(19) United States
(12) Patent Application Publication
(10) Pub. No.: US 2006/0154667 A1
(43) Pub. Date: Jul. 13, 2006

(54) Apparatus and method for configuring sectors in a wireless communication system

(75) Inventors: Jeong-Yeon Seo, Seoul (KR); Young-Hoon Kwon, Seongnam-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/328,356

(22) Filed: Jan. 9, 2006

(30) Foreign Application Priority Data
Jan. 7, 2005 (KR) 2005-1676

(51) Int. Cl. H04Q 7/20

(52) U.S. Cl. 455/446

(57) ABSTRACT

An apparatus and method is provided for configuring a sector in a multi-antenna mobile communication system. A cell is divided into a plurality of sectors, and a plurality of beams are formed for each of the divided sectors. The formed beams are allocated to the sectors in such a manner that a first beam of a second sector is spatially adjacent to a first beam of a first sector, so a plurality of beams allocated to one sector are spatially discontinuous and adjacent beams are formed for different sectors.

### PRIORITY

This application claims the benefit under 35 U.S.C. § 119(a) of an application entitled “Apparatus and Method for Configuring Sectors in a Wireless Communication System” filed in the Korean Intellectual Property Office on Jan. 7, 2005 and assigned Serial No. 2005-1676, the entire contents of which are incorporated herein by reference.

### BACKGROUND OF THE INVENTION

1. Field of the Invention

The present invention relates generally to a wireless communication system, and in particular, to an apparatus and method capable of increasing capacity of a base station (BS) in a communication system using multiple antennas (hereinafter referred to as a “multi-antenna communication system”).

2. Description of the Related Art

In general, capacity and performance of a wireless communication system are basically restricted by radio propagation channel characteristics, such as co-channel interference, path loss, multipath fading, signal delay, Doppler spread, and shadowing, all of which occur between cells or in the cells. Therefore, current mobile communication systems employ power control, channel coding, Rake reception, diversity antenna, cell sectorization, frequency division, and direct sequence spread spectrum (DSSS) technologies for compensating for the restriction of capacity and performance.

However, as the demand for a wireless communication service is diversified and increased, there are many difficulties in satisfying a high-performance, high-capacity service simply with the conventional technology. In addition, there is also an increasing demand for various high-performance data and image service systems for packet and image signal transmission. Therefore, the future wireless communication system, compared with the conventional cellular and Personal Communication Service (PCS) communication systems, will provide a multimedia communication service that requires higher quality and higher capacity. In addition, the future wireless communication system will be required to provide a high-quality voice service, which is similar to or higher than a wired communication service in terms of call quality.

In order to meet the foregoing requirements, research is being conducted on solutions for performance degradation due to interference signals and channel characteristics. For example, research is being performed on a smart antenna technology for increasing BS capacity and minimizing signal interference between mobile stations (MSs), using a plurality of antennas.

The smart antenna technology, unlike the conventional technology for combining multipath signals using two diversity antennas, uses an array antenna and an up-to-date high-capacity digital signal processing technology. That is, the smart antenna technology is an up-to-date signal processing and antenna technology that enables maximization of the transmission/reception performance and capacity by performing adaptive antenna beam pattern control according to a variation in a radio frequency (RF) signal environment. The smart antenna technology radiates a directional beam only to a corresponding subscriber, instead of forming an omnidirectionally radiated beam, thereby to minimize signal interference between all subscribers located in a sector, thus contributing to an increase in communication quality and system channel capacity.

A smart antenna can be located in a BS and/or an MS according to its antenna array size. The smart antenna, when it is located in a BS, adaptively receives a signal from a desired direction in an uplink, and adaptively transmits a signal to a desired direction in a downlink. In this manner, the smart antenna can increase antenna gain and diversity gain for a desired user, and reduce interference signals received from different directions in the uplink or interference signals transmitted to different directions in the downlink.

A schematic configuration of the smart antenna and its function will now be described below.

1) Antenna Array: The antenna array is comprised of a plurality of antennas and generates a desired antenna beam pattern. An increase in number of the antennas narrows a beam pattern, increasing performance, but it commonly uses between 4 and 12 antennas taking system complexity into consideration. It is classified into Uniform Linear Array (ULA) and Uniform Circular Array (UCA) according to antenna type.

2) RF Transceiver: The number of RF transceivers used is equal to the number of antenna elements, and the RF transceiver is implemented with an Up/Down converter radio frequency/intermediate frequency (RF/IF) module for an RF input/output signal received from each antenna element.

3) Beamformer: The beamformer uses a switched beamforming scheme and an adaptive beamforming scheme as a method for forming a beam to a desired user direction. The switched beamforming scheme forms beams by previously setting weight vectors for several directions, and the adaptive beamforming scheme continuously updates weight vectors according to a location of a desired user such that a signal-to-interference ratio (SIR) for the desired user is maximized.

For beamforming, various adaptive algorithms are used to calculate weight vectors. The adaptive algorithm commonly includes a method for calculating weight vectors according to Direction-of-Arrival (DOA) and a method for calculating weight vectors according to Time Reference, and requires an up-to-date digital signal processing (DSP) technology for real-time calculation of weight vectors for beamforming.

4) RF Calibration: RF calibration provides a great change in amplitude and phase of a high-frequency carrier despite a fine characteristic difference between array antenna elements of a multi-channel receiver, basically causing a reduction in performance of a beamformer. Therefore, it is necessary to compensate for a characteristic difference between antenna elements, and calibrate a difference between array antenna elements in terms of amplitude and phase of an RF channel transceiver. For calibration of an antenna error, off-line calibration is generally used, and for calibration of an RF channel error, on-line calibration is used. A real system requires on-line calibration capable of compensating for the error by real-time control.

A Space Division Multiple Access (SDMA) scheme refers to a type of multiple access scheme that multiplexes signals from a plurality of BSs in a satellite, using a plurality of regional spot beam antennas. The SDMA scheme optimizes use of a radio spectrum and minimizes the system cost by taking advantage of the directional characteristic of a parabolic dish antenna.

The multi-antenna wireless communication system described above is advantageous in that it can extend system capacity and increase its coverage. In addition, the multi-antenna wireless communication system can also allow users to prevent interference with each other by spatially separating the same resource using the SDMA scheme.

The reason why the SDMA scheme is important in the multi-antenna wireless communication system is because it can allocate resources to more users, i.e., MSs, using the same hardware resource without additionally installing the hardware, and also reduce the cost required for system implementation due to the efficient use of the resources.

In the multi-antenna wireless communication system, the conventional technology for supporting the SDMA scheme can be roughly divided into two schemes: one is the switched beamforming scheme and another is the adaptive beamforming, and a description thereof will be made below with reference to FIGS. 1 and 2.

FIG. 1 is a diagram schematically illustrating a sector configuration based on a switched beamforming scheme (hereinafter referred to as “switched beamforming-based sector configuration”) according to the prior art.

The switched beamforming scheme, as described above, forms beams by previously setting weight vectors for several directions. Referring to FIG. 1, the switched beamforming has a configuration of several previously fixed beams, and then switching the beams as a user, i.e., MS, moves.

Disadvantageously, however, the sector configuration based on the switched beamforming scheme has a low reuse factor for the same resource. That is, in a configuration where α1 101, α2 103, α3 105 and α4 107 are located in the same sector as shown in FIG. 1, the same resource cannot be allocated to adjacent beams. In this situation, if the same resource is allocated, interference occurs in an overlapping area between the adjacent beams. Therefore, the switched beamforming-based sector configuration has no choice but to restrictively use the SDMA scheme.

In the switched beamforming-based sector configuration, phase mismatch occurs in the beam overlapping area in the same sector. Therefore, an MS suffers performance degradation, like deep fading.

As described above, the switched beamforming-based sector configuration is disadvantageous in that it has a low reuse factor for the same resource, and decreases in performance during beam switching.

FIG. 2 is a diagram schematically illustrating a sector configuration based on an adaptive beamforming scheme (hereinafter referred to as “adaptive beamforming-based sector configuration”) according to the prior art.

The adaptive beamforming scheme, as described above, continuously updates weight vectors according to a location of a desired user such that an SIR for the desired user, i.e., an MS, is maximized. Referring to FIG. 2, the adaptive beamforming has a configuration of forming a beam toward a user, or MS, in real time as the MS moves.

If beam#1 201 and beam#2 203 do not overlap as illustrated in FIG. 2, the adaptive beamforming-base sector configuration can use the SDMA scheme. However, the adaptive beamforming scheme should adaptively make beam coefficients in real time according to a measured channel state of an MS, while monitoring a channel state of each MS. Therefore, calculation for generating the beam coefficients increases with the number of MSs, requiring a high processing capability. The increase in the calculation processing increases implementation complexity.

Accordingly, there is a need for a scheme capable of efficiently configuring a multi-antenna system using a new sector configuration that is different from the conventional switched beamforming-based sector configuration and adaptive beamforming-based sector configuration in the multi-antenna mobile communication system.

### SUMMARY OF THE INVENTION

It is, therefore, an object of the present invention to provide a sector configuration capable of minimizing signal interference between MSs in a cell.

It is another object of the present invention to provide an efficient sector configuring apparatus and method capable of increasing capacity of a system (base station) in a multi-antenna wireless communication environment by applying a new sector configuration.

It is further another object of the present invention to provide a new sector design scheme capable of improving system capacity and performance by maximally applying an SDMA scheme in a multi-antenna communication system.

According to one aspect of the present invention, there is provided a method for configuring a sector in a wireless communication system. The method includes dividing a cell into a plurality of sectors, and forming a plurality of beams for each of the divided sectors; and allocating the formed beams to the sectors in such a manner that a first beam of a second sector is spatially adjacent to a first beam of a first sector, so a plurality of beams allocated to one sector are spatially discontinuous and adjacent beams are formed for different sectors.

According to another aspect of the present invention, there is provided a method for configuring a sector in a wireless communication system. The method includes generating a beam coefficient for each individual angle previously set according to a system environment; mapping beams to sectors, and generating a mapping table including beam allocation information for each sector; after generating the mapping table, forming a beam using the beam coefficient for each individual angle; selecting a specific beam with the highest power for the formed beam; searching the mapping table for information mapped to the selected beam; if there is an available resource for the corresponding beam, allocating the available resource to each channel element; and causing the channel element to perform channel processing using the allocated available resource.

According to further another aspect of the present invention, there is provided a method for allocating resources in a multi-antenna communication system. The method includes upon receiving access channel information from a mobile station (MS), analyzing information on a beam formed for the MS and selecting a beam with the highest power; searching for sector information and beam information for the selected beam; allocating an available resource in the corresponding beam according to the searched information; and transmitting information on the allocated resource to a channel element.

According to yet another aspect of the present invention, there is provided a base station (BS) apparatus in a multi-antenna communication system. The BS apparatus includes a beamforming device for forming a plurality of beams for each of a plurality of sectors, and allocating the formed beams to each of the sectors such that the same sector includes a plurality of discontinuous beams; a resource allocator for providing mobile stations (MS) located in different beams in the same sector with the same resource; and a channel element for processing each channel using information on the resource allocated for each channel by the resource allocator.

### BRIEF DESCRIPTION OF THE DRAWINGS

The above and other objects, features and advantages of the present invention will become more apparent from the following detailed description when taken in conjunction with the accompanying drawings in which:

FIG. 1 is a diagram schematically illustrating a switched beamforming-based sector configuration according to the prior art;

FIG. 2 is a diagram schematically illustrating an adaptive beamforming-based sector configuration according to the prior art;

FIG. 3 is a diagram illustrating a sector configuration in a communication system according to an embodiment of the present invention;

FIG. 4 is a block diagram schematically illustrating a structure of a BS receiver according to an embodiment of the present invention;

FIG. 5 is a flowchart illustrating a signal processing process between a BS and an MS in a communication system according to an embodiment of the present invention; and

FIG. 6 is a diagram illustrating exemplary application of an SDMA scheme using a novel sector configuration according to an embodiment of the present invention.

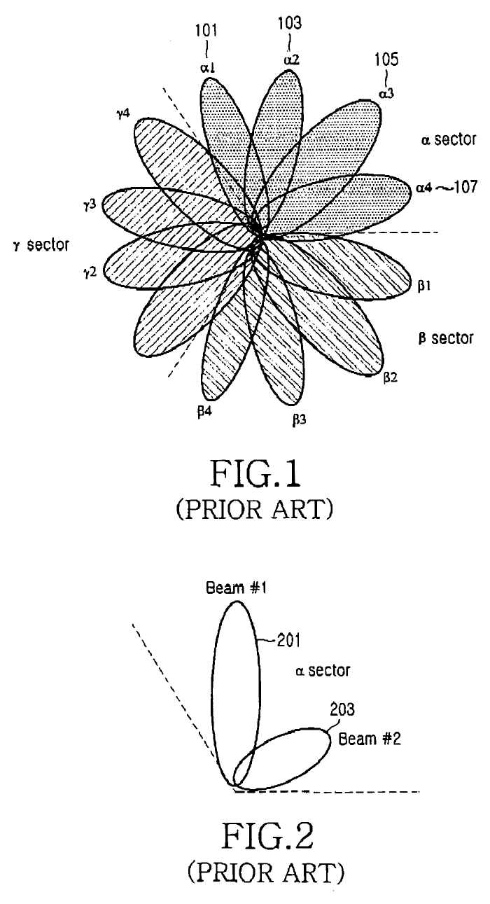

### DETAILED DESCRIPTION OF PREFERRED EMBODIMENTS

Preferred embodiments of the present invention will now be described in detail with reference to the annexed drawings. In the following description, a detailed description of known functions and configurations incorporated herein has been omitted for clarity and conciseness.

The present invention provides a sector configuring apparatus and method capable of increasing system capacity and performance in a wireless communication system, especially in a communication system using multiple antennas (hereinafter referred to as a “multi-antenna communication system”). Specifically, an embodiment of the present invention provides a scheme for designing a new sector configuration of a base station (BS), capable of maximally using a Space Division Multiple Access (SDMA) scheme by arranging sectors using a new beamforming scheme different from the conventional switched beamforming scheme and adaptive beamforming scheme in implementing the multiple-antenna communication system.

As to the multiple beams in the conventional multi-antenna system, several beams exist in one sector as described above. However, the present invention provides a new scheme of dividing the same sector into discontinuous spaces. The new scheme can also be applied to another mobile communication system environment in which the number of sectors and the number of beams are different.

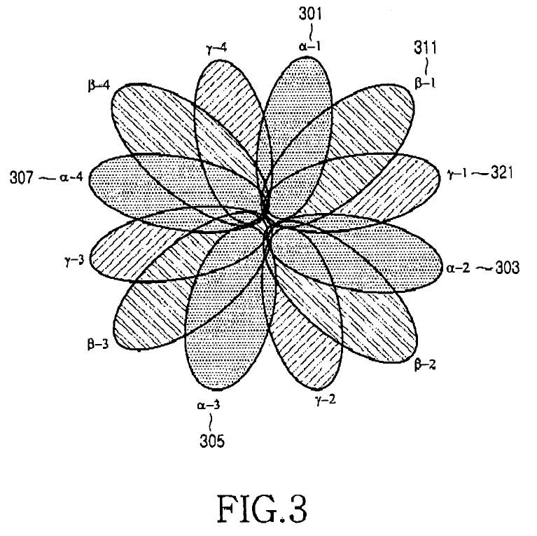

FIG. 3 is a diagram illustrating a sector configuration in a communication system according to the present invention.

Before a description of FIG. 3 is given, it should be noted that the present invention will be described with reference to a 3-sector, 12-beam configuration, by way of example. For example, the sector configuration includes 3 sectors of α sector, β sector and γ sector, and 12 beams of α-1, α-2, α-3, α-4, β-1, β-2, β-3, β-4, γ-1, γ-2, γ-3, and γ-4.

Referring to FIG. 3, a sector configuration according to the present invention is configured such that 4 beams formed for the same sector are formed in discontinuous spaces. That is, for example, 4 beams formed in the α sector are formed as α-1 301, α-2 303, α-3 305 and α-4 307 in discontinuous spaces as shown in FIG. 3. Similarly, multiple beams divided into discontinuous spaces are formed in the β sector and the γ sector, as done in the α sector.

As to the adjacent beams of, for example, α-1 301, β-1 311 and γ-1 321, they are formed in different sectors of the α, β and γ sectors, respectively. Using this sector configuration, the present invention can remove possible performance degradation due to phase mismatch occurring during beam switching, and can also maximally use the SDMA scheme.

In the present invention, adjacent beams have different phase noises (PNs) according to sector, because they are formed in different sectors as illustrated in FIG. 3. Therefore, during handoff, no phase mismatch occurs in a sector overlapping area, preventing performance degradation. In addition, the present invention can allocate the same resource to the adjacent beams, because they are formed in the different sectors.

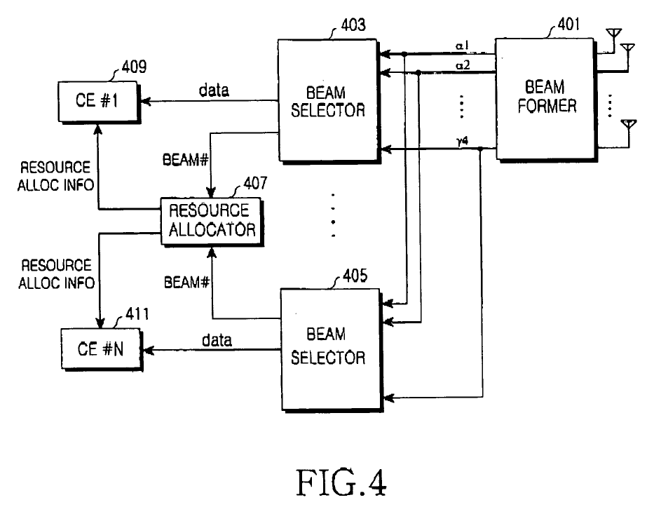

The foregoing sector configuration will now be described in more detail with reference to FIGS. 4 through 6.

FIG. 4 is a block diagram schematically illustrating a structure of a BS receiver according to the present invention.

Referring to FIG. 4, a BS receiver according to the present invention includes a plurality of antennas, a beamformer 401 for forming beams for MSs, a plurality of beam selectors 403 through 405 for selecting a beam with highest power by analyzing information mapped to the formed beams, a resource allocator 407 for allocating available resources by searching for sector information and beam information of the selected beam and providing the allocation information to a channel element, and first through N^{th} channel elements (CEs) 409 through 411 for processing their associated channels using information on the resources allocated to their associated channels.

An embodiment of the present invention provides for, using the foregoing configuration designs, a sector configuration such that the same resource is allocated to the users, i.e., MSs, located in different beams in the same discontinuous sector. In other words, referring to an exemplary sector configuration of FIG. 3, a BS transmits pilots for 3 sectors with 12 beams.

If the MS attempts an access to a BS, the BS finds sector information and beam information of the MS that attempted an access thereto, through the foregoing receiver structure and an exemplary operation of the receiver, described below. Thereafter, the BS independently performs scheduling for each of the found individual beams, combines traffic for each of the individual beams, multiplies the combined traffic by a beam coefficient, and then transmits the multiplication result to the MS.

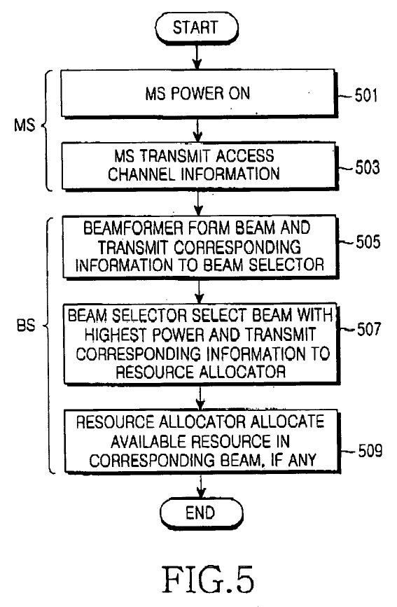

An operation of the BS receiver will now be described with reference to FIG. 5.

FIG. 5 is a flowchart illustrates a signal processing process between a BS and an MS in a communication system according to the present invention.

Referring to FIG. 5, if an MS is powered on in step 501, it transmits access channel information for an access to the BS in step 503. Then the BS searches for sector information and beam information of the MS that attempted the access thereto and forms a beam for the MS according thereto, using a beamformer. Thereafter, the beamformer transmits information on the beam formed for the MS to a beam selector in step 505.

Then the beam selector selects a beam with the highest power by analyzing the beam forming information received from the beamformer, and transmits information on the selected beam to a resource allocator in step 507. Finally, the resource allocator determines whether there is an available resource in a corresponding beam depending on the received selected beam information, and allocates a resource for the MS, if any, in step 509. Thereafter, the resource allocator transmits information on the allocated resource to a corresponding channel element.

An exemplary method of configuring a sector configuration will now be described.

A BS operates based on the information which is set according to system setup. That is, the BS, before its operation, stores a beam coefficient previously calculated by a system operator for each individual angle, in its beamformer, and generates beam coefficients according to the system environment. For example, the BS generates beam coefficients for 3 sectors and 12 beams.

After generation of the beam coefficients, the BS generates a mapping table in which beams and sectors are mapped. Preferably, the mapping table is generated by a system operator such that sector information and beam information are mapped to associated parameters according to system setup condition, for example, for 3 sectors and 12 beams. Also, preferably, the BS includes a recording medium, for example, a buffer for recording the mapping table in which the mapping information is mapped to the sector information and the beam information.

An example of the mapping table is shown in Table 1, and the exemplary mapping table shown in Table 1 includes mapping information for each sector configuration.

TABLE 1

| Beam Number | Sector | Beam # in Sector |
|---|---|---|
| 1 | Alpha | Beam #1 |
| 2 | Beta | Beam #1 |
| 3 | Gamma | Beam #1 |
| 4 | Alpha | Beam #1 |
| 5 | Beta | Beam #2 |
| 6 | Gamma | Beam #2 |
| 7 | Alpha | Beam #2 |
| 8 | Beta | Beam #2 |
| 9 | Gamma | Beam #3 |
| 10 | Alpha | Beam #3 |
| 11 | Beta | Beam #3 |
| 12 | Gamma | Beam #3 |

Table 1 shows an exemplary mapping table for a 3-sector, 12-beam configuration, in which 4 beams are formed for each of 3 sectors.

After generating the mapping table, the BS applies a beam coefficient for each individual angle to a beamformer 401 shown in FIG. 4. Next, beam selectors 403 through 405 transmit selected beam numbers to a resource allocator 407. Then the resource allocator 407 generates resource allocation information through a series of resource allocation operations depending on the mapping table of Table 1.

Thereafter, the resource allocator 407 provides the generated resource allocation information to each of channel elements 409 through 411 shown in FIG. 4. Upon receiving the resource allocation information, the channel elements 409 through 411 perform their operations according to the resource allocation information.

The channel elements 409 through 411, which are channel processors, process their channels using information associated with the channels, for example, sector information or Walsh information.

As described above, a sector configuration according to an embodiment of the present invention is implemented using the mapping table shown in Table 1. Therefore, it will be understood by those skilled in the art that the BS can operate with a different sector configuration by simply modifying the mapping table.

An exemplary operation of a resource allocator according to the present invention will now be described with reference to the mapping table.

The resource allocator according to the present invention manages a resource management list for each of channel processors, i.e., channel elements. The resource allocator, upon receipt of information on selected beams from the beam selectors, converts the beam selection results of the beam selectors separately into sector information and beam information using the mapping table shown in Table 1.

Thereafter, the resource allocator determines whether there is an available resource depending on the resource management list mapped to the corresponding beam. If there is an available resource for the corresponding beam in the resource management list, the resource allocator allocates the available resource to a corresponding channel processor, and then updates the resource management list and reports the resource allocation result to an upper processor.

If, however, there is no available resource for the corresponding beam in the resource management list, the resource allocator preferably allocates no resource for the corresponding beam and then reports the result to the upper layer.

The channel processor, which is allocated the available resource, performs a corresponding operation, for example, channel processing, using the information on the allocated resource.

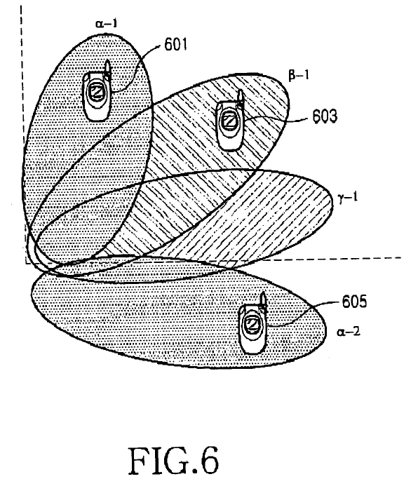

FIG. 6 is a diagram illustrating exemplary application of an SDMA scheme using a novel sector configuration according to the present invention.

It is assumed in FIG. 6 that a first MS 601 is located in a first beam α-1 of an α sector, a second MS 603 is located in a first beam β-1 of a β sector, and a third MS 605 is located in a second beam α-2 of the α sector.

Referring to FIG. 6, although the first MS 601 and the second MS 603 are located in the adjacent beams α-1 and β-1, they are mapped to different sectors. That is, the first MS 601 is mapped to the a sector, and the second MS 603 is mapped to the β sector. Therefore, a BS can allocate the same resource, for example, the same Walsh information, to the first MS 601 and the second MS 603.

In addition, the first MS 601 and the third MS 605 are spatially separated from each other even though they are located in the same sector, i.e., in the α sector, so the BS can allocate the same resource allocation information, for example, the same Walsh information, to the first MS 601 and the third MS 605.

As described above, the present invention can allocate the same resource to a plurality of MSs located in the same sector, maximizing utilization of the SDMA scheme. The allocation of the same channel resource to MSs facilitates efficient system implementation and contributes to improvement in system performance.

As can be understood from the foregoing description, the present invention provides a scheme for designing a new sector configuration in a wireless communication system, thereby making it possible to efficiently configure a multi-antenna mobile communication system. Application of the new sector configuration contributes to an increase in system (BS) capacity in a multi-antenna mobile communication environment.

Further, in implementing a multi-antenna mobile communication system, sector arrangement is achieved such that the SDMA scheme can be maximally used, improving system capacity and performance. In addition, it is possible to satisfy both the maximum utilization of the SDMA scheme, which is a merit of the adaptive beamforming, and the simple implementation, which is a strong point of the switching beamforming.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A method for configuring a sector in a wireless communication system, the method comprising the steps of:
dividing a cell into a plurality of sectors, and forming a plurality of beams for each of the divided sectors; and
allocating the formed beams to the sectors in such a manner that a first beam of a second sector is spatially adjacent to a first beam of a first sector, so a plurality of beams allocated to one sector are spatially discontinuous and adjacent beams are formed for different sectors.

2. The method of claim 1, wherein information on the allocated beams is generated depending on a mapping table previously set according to a system environment.

3. A method for configuring a sector in a wireless communication system, the method comprising the steps of:
generating a beam coefficient for each individual angle previously set according to a system environment;
mapping beams to sectors, and generating a mapping table including beam allocation information for each sector;
after generating the mapping table, forming a beam using the beam coefficient for each individual angle;
selecting a specific beam with the highest power for the formed beam;
searching the mapping table for information mapped to the selected beam;
if there is an available resource for the corresponding beam, allocating the available resource to each channel element; and
causing the channel element to perform channel processing using the allocated available resource.

4. The method of claim 3, wherein the channel element performs channel processing according to information on the allocated resource.

5. The method of claim 3, further comprising the step of, if there is no available resource for the corresponding beam, allocating no resource to the corresponding beam according to system setup.

6. The method of claim 3, wherein the resource allocation step comprises allocating the same resource information for different mobile stations (MSs) that are located in adjacent beams and belonging to different sectors, and allocating the same resource information for different MSs that are located in spatially separated beams and belonging to the same sector.

7. A method for allocating resources in a multi-antenna communication system, the method comprising the steps of:
upon receiving access channel information from a mobile station (MS), analyzing information on a beam formed for the MS and selecting a beam with the highest power;
searching for sector information and beam information for the selected beam;
allocating an available resource in the corresponding beam according to the searched information; and
transmitting information on the allocated resource to a channel element.

8. The method of claim 7, wherein the channel element performs channel processing according to the information on the allocated resource.

9. The method of claim 7, further comprising searching a mapping table including beam allocation information for each sector for information mapped to the selected beam, generating resource allocation information according to the searched information, and transmitting the generated resource allocation information to each channel element.

10. The method of claim 7, wherein the resource allocation step comprises allocating the same resource information for different MSs that are located in adjacent beams and belonging to different sectors, and allocating the same resource information for different MSs that are located in spatially separated beams and belonging to the same sector.

11. A base station (BS) apparatus in a multi-antenna communication system, the apparatus comprising:
a beamforming device for forming a plurality of beams for each of a plurality of sectors, and allocating the formed beams to each of the sectors such that the same sector includes a plurality of discontinuous beams;
a resource allocator for providing mobile stations (MS) located in different beams in the same sector with the same resource; and
a channel element for processing each channel using information on the resource allocated for each channel by the resource allocator.

12. The BS apparatus of claim 11, further comprising a recording medium for storing a mapping table including information on a sector configuration spatially divided into discontinuous beams and mapping information corresponding to the sector configuration information, wherein the mapping table includes beam allocation information mapped to each sector.

13. The BS apparatus of claim 12, wherein the resource allocator searches the mapping table for sector information and beam information for the beam, and allocates an available resource in the corresponding beam according to the searched information.

14. The BS apparatus of claim 11, wherein the channel element performs channel processing on each channel according to at least one of sector information and Walsh information for the channel.

15. The BS apparatus of claim 11, wherein the resource allocator allocates the same resource information for different MSs that are located in adjacent beams and belonging to different sectors, and allocates the same resource information for different MSs that are located in spatially separated beams and belonging to the same sector.

16. The BS apparatus of claim 11, wherein the beamforming device comprises:
a beamformer for, upon receiving access channel information from a particular MS, forming a beam for the MS; and
a beam selector for analyzing information on the beam formed for the MS and selecting a beam with the highest power;
wherein the beamforming device divides a particular cell into a plurality of sectors, forms a plurality of beams for each of the divided sectors, and allocates the formed beams to each of the sectors.

17. The BS apparatus of claim 11, wherein the resource allocator allocates the formed beams to the sectors in such a manner that a first beam of a second sector is spatially adjacent to a first beam of a first sector, so a plurality of beams allocated to one sector are spatially discontinuous and adjacent beams are formed for different sectors.
